(19) United States
(12) Patent Application Publication
(10) Pub. No.: US 2015/0083947 A1
(43) Pub. Date: Mar. 26, 2015

(54) BACK PRESSURE REGULATION

(71) Applicant: Waters Technologies Corporation, Milford, MA (US)

(72) Inventors: Joshua A. Shreve, Franklin, MA (US); Edwin Denecke, North Attleboro, MA (US); Robert A. Jencks, Mendon, MA (US)

(73) Assignee: Waters Technologies Corporation, Milford, MA (US)

(21) Appl. No.: 14/382,603

(22) PCT Filed: Mar. 4, 2013
(86) PCT No.: PCT/US13/28823

§ 371 Date: Sep. 3, 2014

Related U.S. Application Data
(60) Provisional application No. 61/608,219, filed on Mar. 8, 2012.

(51) Int. Cl. F16K 1/38; G01N 30/60; F16K 25/00

(52) U.S. Cl. CPC F16K 1/385; F16K 25/005; G01N 30/60
USPC 251/129.15; 251/324

(57) ABSTRACT

The invention generally provides a dynamic back pressure regulator. In an exemplary embodiment, the back pressure regulator includes an inlet, an outlet, a seat disposed between the inlet and the outlet and defining at least part of a fluid pathway, and a needle displaceable relative to the seat to form a restriction region therebetween for restricting fluid flow between the inlet and the outlet. In some embodiments, the needle can include a corrosion and/or erosion resistant polymer tip.

### RELATED APPLICATION

This application claims priority to and benefit of U.S. Provisional Patent Application No. 61/608,219 entitled “Back Pressure Regulation,” filed Mar. 8, 2012, which is incorporated by reference herein in its entirety.

### TECHNICAL FIELD

This disclosure relates to back pressure regulation, and, in one particular implementation, to a dynamic back pressure regulator for a supercritical fluid chromatography system.

### BACKGROUND

Supercritical fluid chromatography (SFC) is a chromatographic separation technique that typically utilizes liquefied carbon dioxide (CO2) as a mobile phase solvent. In order to keep the mobile phase in liquid (or liquid-like density) form, the chromatographic flow path is pressurized; typically to a pressure of at least 1100 psi.

### SUMMARY

This disclosure is based, in part, on the realization that a dynamic back pressure regulator can be provided with a needle having a polymer (e.g., polyether-ether-ketone or polyimide) tip for improved resistance to corrosion and/or erosion.

On aspect provides a dynamic back pressure regulator that includes an inlet, an outlet, a seat disposed between the inlet and the outlet and defining at least part of a fluid pathway, and a needle displaceable relative to the seat to form a restriction region therebetween for restricting fluid flow between the inlet and the outlet. The needle includes a corrosion and erosion resistant polymer tip.

Another aspect features a supercritical fluid chromatography (SFC) system that includes a separation column, at least one pump configured to deliver a mobile phase fluid flow comprising liquefied CO2 toward the separation column, an inject valve configured to introduce a sample plug into the mobile phase fluid flow, and a dynamic back pressure regulator disposed downstream of, and in fluid communication with, the column for regulating pressure in the system. The dynamic back pressure regulator includes an inlet, an outlet, a seat disposed between the inlet and the outlet and defining at least part of a fluid pathway, and a needle displaceable relative to the seat to restrict fluid flow between the inlet and the outlet. The needle includes a corrosion and erosion resistant polymer tip.

According to another aspect, a method includes delivering a mobile phase fluid flow comprising liquefied carbon dioxide (CO2) from a chromatography toward a dynamic back pressure regulator; and passing the mobile phase fluid flow through a restriction region in the dynamic back pressure regulator defined by a seat, and a needle that includes a corrosion and erosion resistant polymer tip.

Implementation can include one or more of the following features.

In some implementations, the corrosion and erosion resistant polymer is selected from polyether-ether-ketone and polyimide.

In certain implementations, the needle includes a stem connected to the tip. The stem is made of a metal.

In some implementations, the metal for the stem is selected from stainless steel, MP35N, and titanium.

In certain implementations, the tip is threadingly connected to the stem.

In some implementations, the tip is overmolded on the stem.

In certain implementations, the stem includes barbs for mounting the tip.

In some implementations, the seat is at least partially formed of a polymer (e.g., polyether-ether-ketone).

In certain implementations, the polymer at least partially forming the seat is filled with between 20 and 50 wt. % carbon fiber (e.g., about 30 wt. % carbon fiber).

In some implementations, the seat is at least partially formed of a chemically resistant ceramic (e.g., sapphire and zirconia).

In certain implementations, the tip includes a tapered portion in the shape of a cone.

In some implementations, the cone has an included angle of about 30 degrees to about 60 degrees.

In certain implementations, the total displacement of the needle relative to seat is about 0.001 inches to about 0.005 inches.

In some implementations, the dynamic back pressure regulator can also include a solenoid configured to limit displacement of the needle relative to the seat to control the restriction of fluid flow.

In certain implementations, the dynamic back pressure regulator can also include a head defining a portion of the fluid pathway, and a body connecting the solenoid to the head,

In some implementations, the needle includes a proximal end that extends into the body, and a distal end that extends into the head.

In certain implementations, the dynamic back pressure regulator also includes a seat nut that engages the head to secure the seat therebetween.

In some implementations, the head defines the inlet port and the seat nut defines the outlet port.

In certain implementations, the dynamic back pressure regulator also includes a seal disposed between the head and the body. The needle extends through the seal.

In some implementations, the dynamic back pressure regulator can also include a bushing disposed between the head and the body, wherein the needle extends through the bushing.

In certain implementations, the dynamic back pressure regulator is configured to regulate fluid pressure at the inlet port to a pressure within the range of about 1500 psi to about 6000 psi.

In some implementations, a flow of electrical current to dynamic back pressure regulator is changed to adjust the size of the restriction region.

In certain implementations, the step of delivering the mobile phase fluid flow from the chromatography column toward the dynamic back pressure regulator includes: delivering the mobile phase fluid flow from the chromatography column toward a detector, and then delivering the mobile phase fluid flow from the detector toward the dynamic back pressure regulator.

Implementations can provide one or more of the following advantages.

Implementations provide a needle that is resistant to corrosion, erosion, or any combination thereof in the back pressure regulator environment of a supercritical fluid chromatography system.

Other aspects, features, and advantages are in the description, drawings, and claims.

### BRIEF DESCRIPTION OF THE DRAWINGS

FIG. 1 is a schematic view of a supercritical fluid chromatography (SFC) system;

FIG. 2 is a schematic view of a dynamic back pressure regulator from the SFC system of FIG. 1;

FIG. 3A is an exploded view of a needle from the dynamic back pressure regulator of

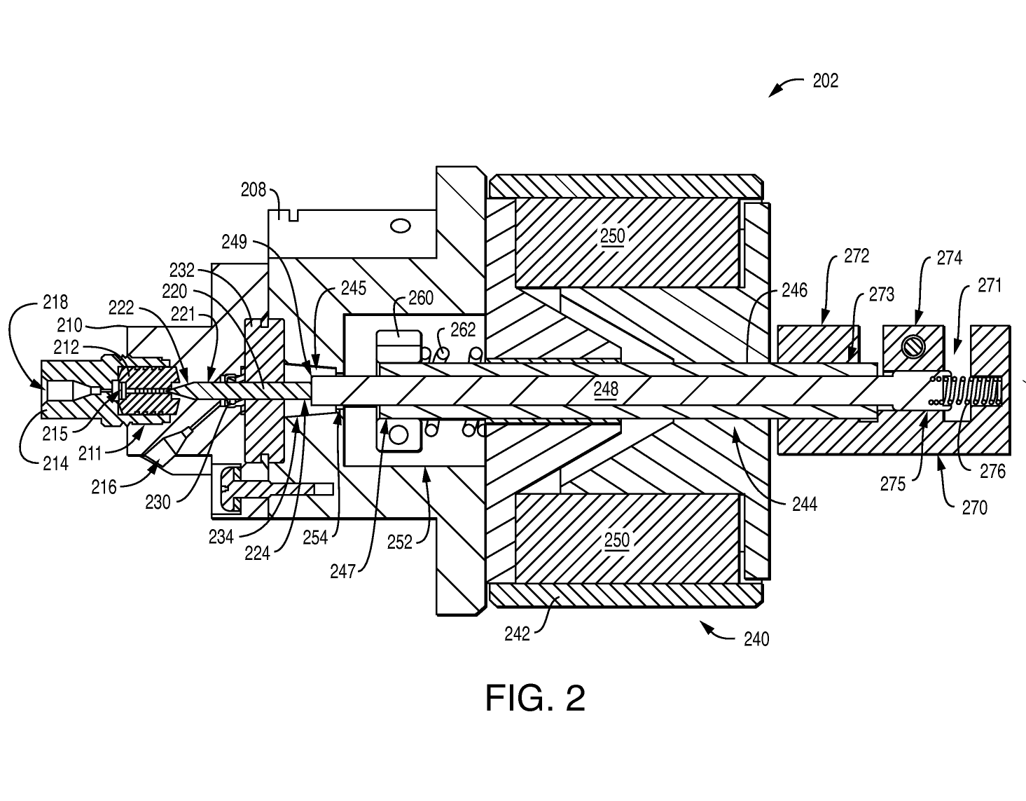

FIG. 2;

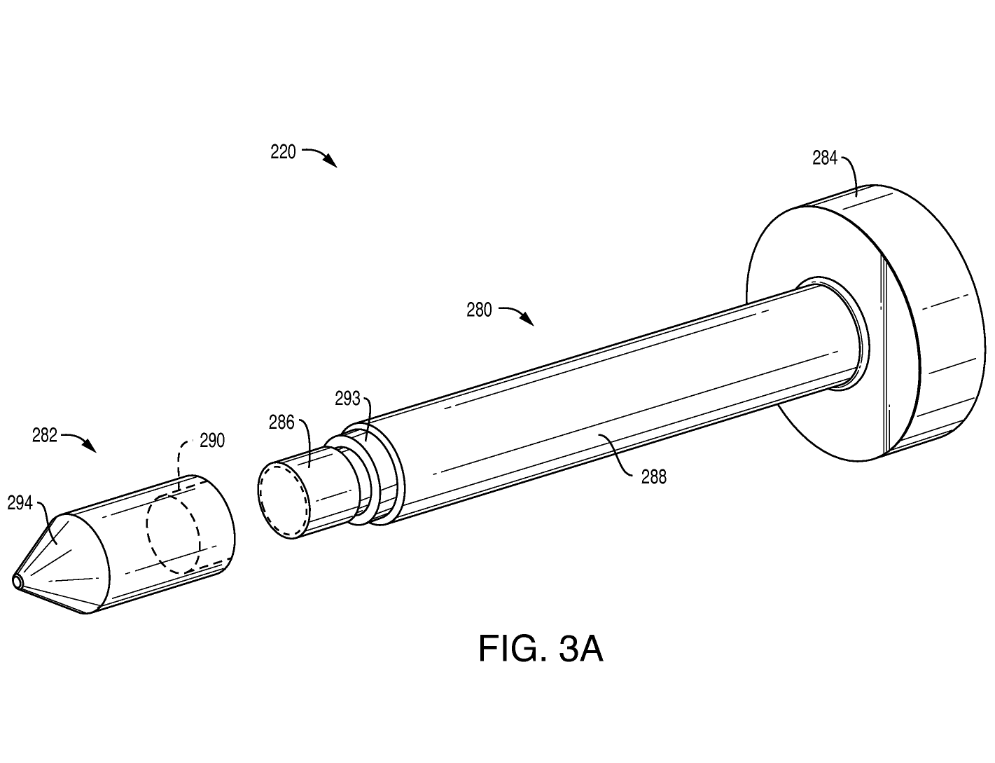

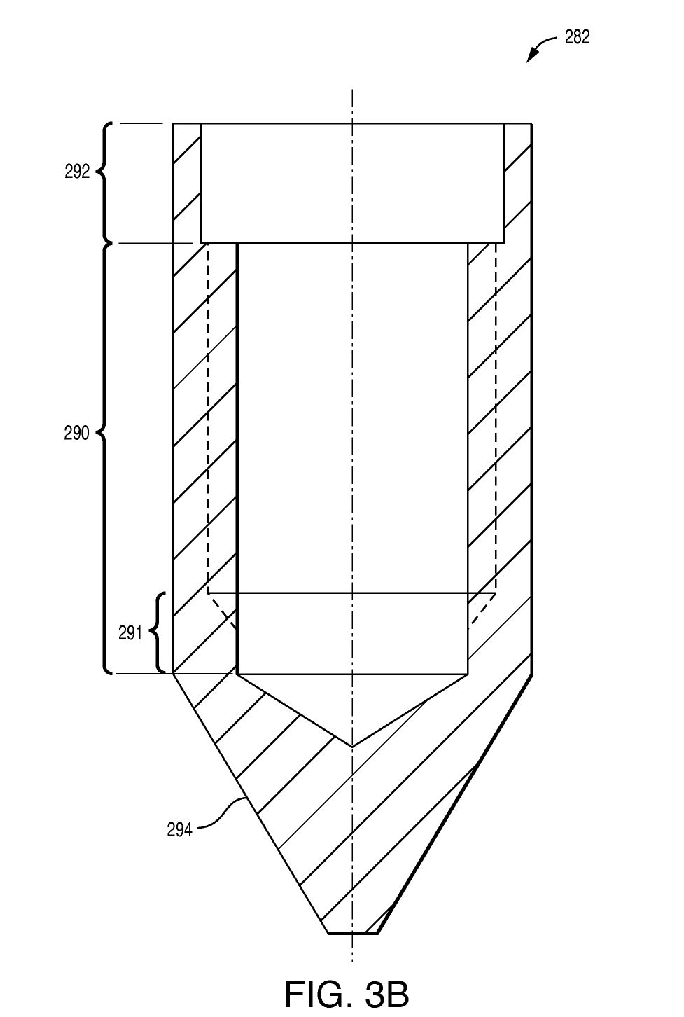

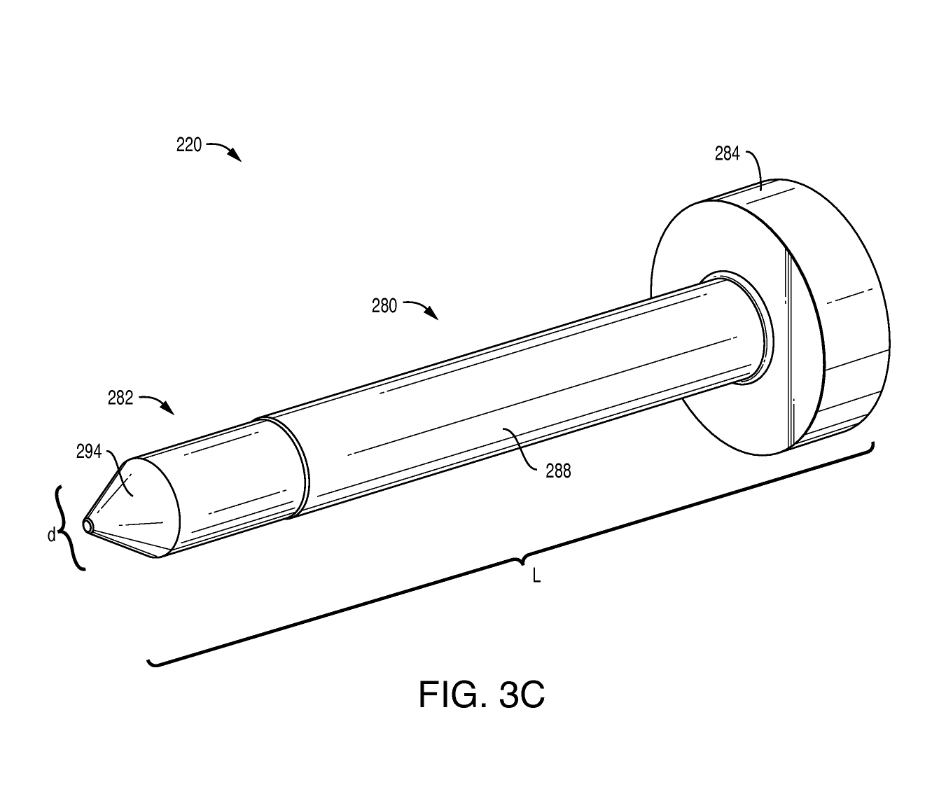

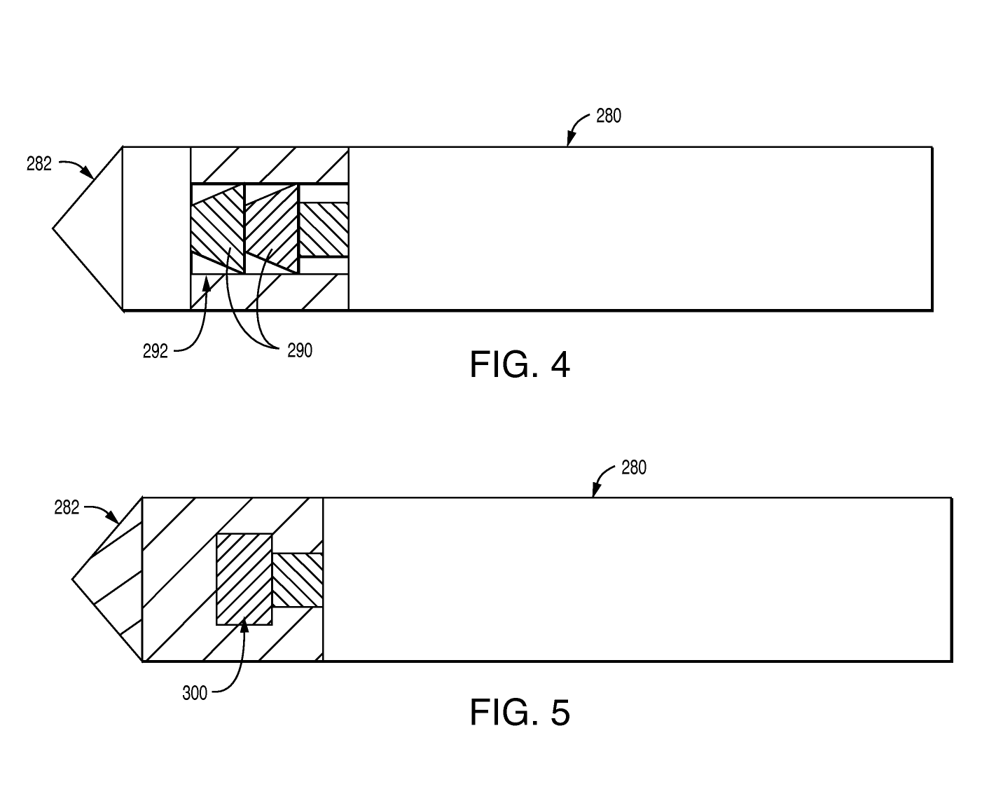

FIG. 3B is a cross-section view of a tip of the needle from FIG. 3A;

FIG. 3C is a perspective view of the needle from the dynamic back pressure regulator of FIG. 2;

FIG. 4 is cross-section view of an implementation of the needle with the tip mounted on the stem via barbs; and

FIG. 5 is a cross-section view of an implementation of the needle with the tip mounted on the stem via overmolding.

Like reference numbers indicate like elements.

### DETAILED DESCRIPTION

### System Overview

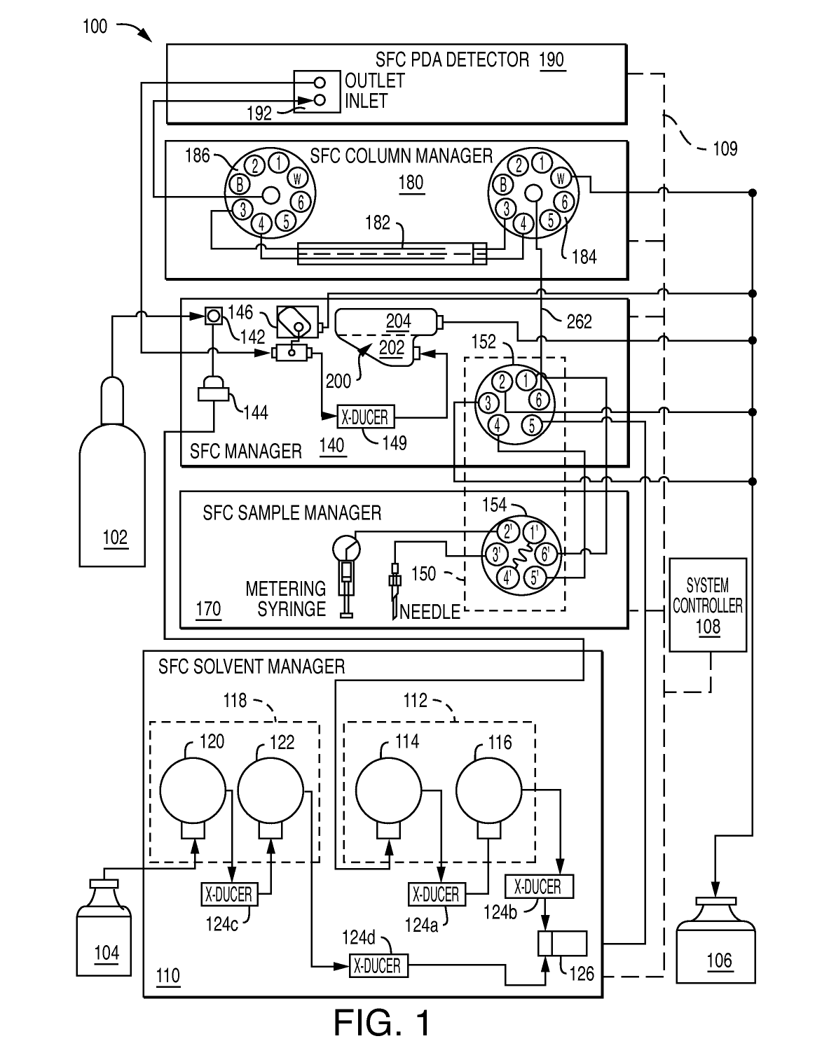

FIG. 1 schematically depicts a supercritical fluid chromatography (SFC) system 100. The SFC system 100 includes a plurality of stackable modules including a solvent manager 110; an SFC manager 140; a sample manager 170; a column manager 180; and a detector module 190.

The solvent manager 110 is comprised of a first pump 112 which receives carbon dioxide (CO2) from CO2 source 102 (e.g., a tank containing compressed CO2). The CO2 passes through an inlet shutoff valve 142 and a filter 144 in the SFC manager 140 on its way to the first pump 112. The first pump 112 can comprise one or more actuators each comprising or connected to cooling means, such as a cooling coil and/or a thermoelectric cooler, for cooling the flow of CO2 as it passes through the first pump 112 to help ensure that the CO2 fluid flow is deliverable in liquid form. In some cases, the first pump 112 comprises a primary actuator 114 and an accumulator actuator 116. The primary and accumulator actuators 114, 116 each include an associated pump head, and are connected in series. The accumulator actuator 116 delivers CO2 to the system 100. The primary actuator 114 delivers CO2 to the system 100 while refilling the accumulator actuator 116.

In some cases, the solvent manager 110 also includes a second pump 118 for receiving an organic co-solvent (e.g., methanol, water (H2O), etc.) from a co-solvent source 104 and delivering it to the system 110. The second pump 118 can comprise a primary actuator 120 and an accumulator actuator 122, each including an associated pump head. The primary and accumulator actuators 120, 122 of the second pump 118 are connected in series. The accumulator actuator 122 delivers co-solvent to the system 100. The primary actuator 120 delivers co-solvent to the system 100 while refilling the accumulator actuator 122.

Transducers 124a-d are connected to outlets of the respective pump heads for monitoring pressure. The solvent manager 110 also includes electrical drives for driving the primary actuators 114, 120 and the accumulator actuators 116, 122. The CO2 and co-solvent fluid flows from the first and second pumps 112, 118, respectively, and are mixed at a tee 126 forming a mobile phase fluid flow that continues to an injection valve subsystem 150, which injects a sample slug for separation into the mobile phase fluid flow.

In the illustrated example, the injection valve subsystem 150 is comprised of an auxiliary valve 152 that is disposed in the SFC manager 140 and an inject valve 154 that is disposed in the sample manager 170. The auxiliary valve 152 and the inject valve 152 are fluidically connected and the operations of these two valves are coordinated to introduce a sample plug into the mobile phase fluid flow. The inject valve 154 is operable to draw up a sample plug from a sample source (e.g., a vial) in the sample manager 170 and the auxiliary valve 152 is operable to control the flow of mobile phase fluid into and out of the inject valve 154. The SFC manager 140 also includes a valve actuator for actuating the auxiliary valve 152 and electrical drives for driving the valve actuations. Similarly, the sample manager 170 includes a valve actuator for actuating the inject valve and 154 and electrical drives for driving the valve actuations.

From the injection valve subsystem 150, the mobile phase flow containing the injected sample plug continues through a separation column 182 in the column manager 180, where the sample plug is separated into its individual component parts. The column manager 180 comprises a plurality of such separation columns, and inlet and outlet switching valves 184, 186 for switching between the various separation columns.

After passing through the separation column 182, the mobile phase fluid flow continues on to a detector 192 (e.g., a flow cell/photodiode array type detector) housed within the detector module 190 then through a vent valve 146 and then on to a back pressure regulator assembly 200 in the SFC manager 140 before being exhausted to waste 106. A transducer 149 is provided between the vent valve 146 and the back pressure regulator assembly 200.

The back pressure regulator assembly 200 includes a dynamic (active) back pressure regulator 202 and a static (passive) back pressure regulator 204 arranged in series. The dynamic back pressure regulator 202, which is discussed in greater detail below, is adjustable to control or modify the system fluid pressure. This allows the pressure to be changed from run to run. The properties of CO2 affect how quickly compounds are extracted from the column 182, so the ability to change the pressure can allow for different separation based on pressure.

The static back pressure regulator 204 is a passive component (e.g., a check valve) that is set to above the critical pressure, to help ensure that the CO2 is liquid through the dynamic back pressure regulator 202. The dynamic back pressure regulator 202 can control more consistently when it is liquid on both the inlet and the outlet. If the outlet is gas, small reductions in the restriction can cause the CO2 to gasify upstream of the dynamic back pressure regulator 202 causing it to be unable to control. In addition, this arrangement helps to ensure that the static back pressure regulator 204 is the location of phase change. The phase change is endothermic, therefore the phase change location may need to be heated to prevent freezing. By controlling the location of phase change, the heating can be simplified and localized to the static back pressure regulator 204.

Generally, the static back pressure regulator 204 is designed to keep the pressure at the outlet of the dynamic back pressure regulator 202 below 1500 psi but above the minimum pressure necessary to keep the CO2 in liquid phase. In some cases, the static back pressure regulator 204 is designed to regulate the pressure within the range of about 1150 psi (at minimum flow rate) to about 1400 psi (at maximum flow rate). The dynamic back pressure regulator 202 can be used to regulate system pressure in the range of about 1500 psi to about 6000 psi.

Also shown schematically in FIG. 1 is a computerized system controller 108 that can assist in coordinating operation of the SFC system 100. Each of the individual modules 110, 140, 170, 180, 190 also includes its own control electronics, which can interface with each other and with the system controller 108 via an Ethernet connection 109. The control electronics for each module can include non-volatile memory with computer-readable instructions (firmware) for controlling operation of the respective module's components (e.g., the pumps, valves, etc.) in response to signals received from the system controller 108 or from the other modules. Each module's control electronics can also include at least one processor for executing the computer-readable instructions, receiving input, and sending output. The control electronics can also include one or more digital-to-analog (D/A) converters for converting digital output from one of the processors to an analog signal for actuating an associated one of the pumps or valves (e.g., via an associated pump or valve actuator). The control electronics can also include one or more analog-to-digital (A/D) converters for converting an analog signal, such as from system sensors (e.g., pressure transducers), to a digital signal for input to one of the processors. In some cases, some or all of the various features of these control electronics can be integrated in a microcontroller.

### Dynamic Back Pressure Regulator

Referring to FIG. 2, an implementation of a dynamic back pressure regulator 202 for use in chromatographic separations includes a body 208, a head 210 fastened to the body 208, a seat 212, and a seat nut 214 which is threadingly received within a counterbore 211 in the head 210 securing the seat 212 therebetween. The head 210, the seat 212, and the seat nut 214 together define a fluid pathway 215 that connects an inlet port 216 in the head 210 to an outlet port 218 in the seat nut 214. That is, the fluid pathway 215 is formed by the interconnection of cavities and passageways in the head 210, the seat 212, and the seat nut 214. The inlet and outlet ports 216, 218 are each configured to receive a standard compression screw and ferrule connection for connecting fluidic tubing.

The dynamic back pressure regulator 202 also has a needle 220 which extends into the fluid pathway 215. The needle 220 is displaceable relative to the seat 212 to adjust a restriction region defined between the needle 220 and the seat 212 for controlling fluid flow through the fluid pathway 215. During operation, the total displacement of the needle 220 is between about 0.001 inches and 0.005 inches. For example, at about 2000 psi the displacement of the needle 220 is barley 0.001 inches, leaving about a 0.001 inch gap between the needle 220 and seat 212 where fluid can flow. Consequently, the fluid velocity within the dynamic back pressure regulator 202 tends to be high. In general, during normal operation, the needle 220 is not intended to completely seal against the seat 212 in a manner that completely stops flow, but instead is intended to merely restrict the flow to achieve the desired pressure. The seat 212 can be manufactured from polyether-ether-ketone, such as PEEK™ polymer (available from Victrex PLC, Lancashire, United Kingdom), filled with between 20 and 50 wt. % (e.g., 30 wt. %) carbon fiber. Alternatively, the seat 212 can be manufactured from a chemically resistant ceramic such as sapphire or zirconia.

The needle 220 is supported in a through hole 221 in the head 210 and is arranged such that a distal end 222 of the needle 220 is in the fluid pathway 215. The needle 220 passes through a seal 230 which inhibits flowing fluids from passing into the body 208 and extends through a bushing 232. The bushing 232 is secured between the head 210 and a body 208 which is connected to the head 210 (e.g., by means of fasteners such as screws). A proximal end 224 of the needle 220 extends outwardly from the bushing 232 and into a first cavity 234 in the body 208.

The needle 220 can be actuated by a solenoid 240 which is connected to the body 208 (e.g., by means of fasteners such as screws). The solenoid 240 comprises a housing 242 and a plunger 244 that includes an outer shaft 246 and an inner shaft 248. An electrical coil 250 for activating the solenoid 240 is disposed within the housing 242. A distal end portion 245 of the plunger 244 extends through a second cavity 252 in the body 208 and into the fist cavity 234 via a reduced diameter through hole 254. When the solenoid 240 is activated, a distal end 249 of the inner shaft 248 pushes against the proximal end 224 of the needle 220, which displaces the needle 220 towards the seat 212 to restrict fluid flow. Pressure force (fluid) will move the needle 220 until the fluidic pressure force on the needle 220 matches the force applied by the solenoid 240. In this regard, the fluid pressure creates whatever restriction is necessary to equalize the pressure force from the solenoid.

A balancing spring collar 260 is fastened about a distal end 247 of the plunger's outer shaft 246 and retains a balancing spring 262 between the housing 242 and the balancing spring collar 260. The balancing spring 262 is provided to balance the solenoid 240 to have minimal force change through the working stroke of the plunger 244. As the plunger 244 moves out of the magnetic field the force drops off. The balancing spring 262 is selected to make the spring rate positive so that the plunger 244 has a returning force. The chosen spring adds an equivalent to slightly higher positive (stabilizing) spring rate.

A calibration collar 270 is fastened about a proximal end portion 271 of the plunger 244. The calibration collar 270 includes a first clamping section 272 that secures the calibration collar 270 to the proximal end 273 of the outer shaft 246, and a second clamping section 274 that secures the calibration collar 270 to the inner shaft 248. The calibration collar 270 secures a calibration spring 276 between the proximal end 275 of the inner shaft 248 and the calibration collar 270. The calibration spring 276 proves for a mechanical self calibration of the plunger 244 during assembly. That is, during assembly of the dynamic back pressure regulator 202 the first clamping section 272 is fastened to the proximal end 273 of the outer shaft 246 while the second clamping section 274 is left loose to allow the inner shaft 248 to move relative the outer shaft 246. This allows the calibration spring 276 to move the inner shaft 248 into contact with the needle 220. Consequently, the needle 220 is moved into contact with the seat 212, thereby calibrating the needle position. The engagement of the needle 220 with the seat 212 also helps to center the needle 220 and the seat 212. The second clamping section 274 can then be fastened to the inner shaft 248 to inhibit movement of the inner shaft 248 relative to the outer shaft 246 during normal operation.

### Needle

During operation, the dynamic back pressure regulator 202 in the SFC system 100 can provide an exceptionally corrosive and erosive environment for the needle 220 and the seat 212. The combination of CO2 and water or organic solvent can be very corrosive. In addition, the high velocity flow through the restriction region defined between the needle 220 and seat 212 can expose the needle 220 and seat 212 to significant erosive forces. When the two conditions are combined the needle 220 and the seat 212 are exposed to a highly destructive environment, which can lead to degradation of the needle 220, and, consequently, loss of control over the pressure. The pressure drop across the dynamic back pressure regulator 202, from between about 1500 psi to about 6000 psi at the inlet of the dynamic back pressure regulator to between about 1150 psi to about 1400 psi at the outlet of the dynamic back pressure regulator 202 may also result in localized phase change of the CO2 along the needle 220 which can also contribute to erosion.

In the following, the needle 220 is described in more detail with reference to FIGS. 3A & 3B. Notably, the needle 220 can be provided with a corrosion and erosion resistant polymer (e.g., polyether-ether-ketone or polyimide) tip, which is the portion of the needle 220 that forms the restriction region with the seat 212. The utilization of such material can allow the needle 220 to survive the harsh environment that it is exposed to.

Referring to FIG. 3A, the needle 220 includes a stem 280 and a tip 282 that is connected the stem 280 and which forms the restriction region with the seat 212. The stem 280 includes a flange 284, a threaded projection 286, and an elongate shaft 288 that extends between the flange 284 and the threaded projection 286. Following assembly, the flange 284 is disposed within the first cavity 234 in the body 208 and can serve as a hard stop against the bushing 232 (FIG. 2) and a shoulder formed at the junction of the first cavity 234 (FIG. 2) and the reduced diameter through hole 254 (FIG. 2). The stem 280 can be formed from a metal such as stainless steel, MP35N, titanium, etc.

The tip 282 includes a threaded counter bore 290 which mates with the threaded projection 286 to secure the tip 282 to the stem 280. In some cases, the threaded counter bore 290 is provided with an incomplete thread, leaving an unthreaded section 291 (FIG. 3B), which is deformed when the tip 282 is threaded on the stem 280 to provide a deformation fit. The tip 282 may also include another counter bore 292 (FIG. 3B) which has a close fit (e.g., a 0 to 0.002 inch gap) with a shoulder 293 on the stem 280 for alignment to ensure that the tip 282 is straight. The tip 282 also includes a tapered portion in the shape of a cone 294. The cone 282 has an included angle of about 30 degrees to about 60 degrees. The cone 294 cooperates with the seat 212 to restrict fluid flow. The cone 294 also helps to center the seat 212 during assembly. That is, during assembly, as the seat nut 214 is tightened into the head 210 the cone 282 engages a cavity in the proximal end of the seat 212 which assists in centering the seat 212. The tip 282 is formed of a corrosion and erosion resistant polymer (e.g., polyether-ether-ketone, such as PEEK™ polymer (available from Victrex PLC, Lancashire, United Kingdom), or polyimide (available as DuPont™ VESPEL® polyimide from E. I. du Pont de Nemours and Company)).

Referring to FIG. 3C, the needle 220 has an overall length L of about 0.75 inches to about 1.5 inches. The stem 280 and tip 282 have a diameter d of about 0.124 inches to about 0.126 inches (e.g., about 0.125 inches), which leaves a clearance of about 0.005 inches between the shaft 280 and the through hole 221 (FIG. 2) in the head 210 following assembly.

This combination of needle materials provides the structural advantages of a metal stem with a tip that will resist corrosion and erosion when exposed to corrosive chemicals (e.g., carbonic acid) and high fluid velocities. It was found that this needle combined with a carbon fiber filled polyether-ether-ketone seat is extremely well suited to this environment and has shown little to no wear over time. A dynamic back pressure regulator 202 with this arrangement of needle and seat materials remained fully functional following testing at 100 liters of flow at a flow rate of 4 mL/min through the restriction region.

### Other Implementations

Although a few implementations have been described in detail above, other modifications are possible. For example, while an implementation of a needle has been described in which a corrosion and erosion resistant polymer tip is threadingly attached to a rigid metal stem, in some cases, the stem 280 may instead be provided with one or more barbs 290 for engaging a counter bore 292 in the tip 282, as shown in FIG. 4.

Alternatively, the tip may be overmolded on the stem. For example, FIG. 5 illustrates an implementation in which the tip 282 is overmolded on the stem 280. The stem 280 is provided with an overmold feature 300 to help ensure that the overmolded tip 282 does not slip off the stem 280.

While an implementation of a dynamic back pressure regulator has been described which uses a solenoid for regulating the displacement of the needle relative to the seat, some implementations may utilize another type of actuator, e.g., a linear position component, such as a voice coil, for regulating the displacement of the needle.

In addition, although described with respect to SFC applications, the principles can be implemented in back pressure regulators used in other applications which involve the handling of corrosive fluids and/or high velocity fluid flows. In some instances, for example, the back pressure regulators described herein may be desirable for regulating system pressure in other types of chromatography systems, such as high performance liquid chromatography (HPLC) systems.

While implementations have been describe in which the needle tip is formed of a corrosion and erosion resistant polymer, in some cases, the tip may instead include a corrosion and erosion resistant metal plating (e.g., a gold plating or a platinum plating). For example, the tip may be formed of a metal (such as stainless steel, aluminum, titanium) that is provided with a metal plating. Alternatively, the needle tip may be formed (e.g. machined from) a corrosion and erosion resistant metal such as gold or platinum.

Accordingly, other implementations are within the scope of the following claims.

1. A dynamic back pressure regulator comprising:
an inlet,
an outlet,
a seat disposed between the inlet and the outlet and defining at least part of a fluid pathway;
a needle displaceable relative to the seat to form a restriction region therebetween for restricting fluid flow between the inlet and the outlet,
wherein the needle comprises a corrosion and erosion resistant polymer tip.

2. The dynamic back pressure regulator of claim 1, wherein the corrosion and erosion resistant polymer is selected from polyether-ether-ketone and polyimide.

3. The dynamic back pressure regulator of claim 1, wherein the needle comprises a stem connected to the tip, the stem being made of a metal.

4. The dynamic back pressure regulator of claim 3, wherein the metal is selected from stainless steel, MP35N, and titanium.

5. The dynamic back pressure regulator of claim 3, wherein the tip is threadingly connected to the stem.

6. The dynamic back pressure regulator of claim 3, wherein the tip is overmolded on the stem.

7. The dynamic back pressure regulator of claim 3, wherein the stem includes barbs for mounting the tip.

8. The dynamic back pressure regulator of claim 1, wherein the seat is at least partially formed of a polymer.

9. The dynamic back pressure regulator of claim 8, wherein the polymer at least partially forming the seat is polyether-ether-ketone.

10. The dynamic back pressure regulator of claim 8, wherein the polymer at least partially forming the seat is filled with between 20 and 50 wt. % carbon fiber.

11. The dynamic back pressure regulator of claim 10, wherein the polymer at least partially forming the seat is filled with about 30 wt. % carbon fiber.

12. The dynamic back pressure regulator of claim 1, wherein the seat is at least partially formed of a chemically resistant ceramic.

13. The dynamic back pressure regulator of claim 8, wherein the chemically resistant ceramic is selected from sapphire and zirconia.

14. The dynamic back pressure regulator of claim 1, wherein the tip comprises a tapered portion in the shape of a cone.

15. The dynamic back pressure regulator of claim 14, wherein the cone has an included angle of about 30 degrees to about 60 degrees.

16. The dynamic back pressure regulators of claim 1, wherein the total displacement of the needle relative to seat is about 0.001 inches to about 0.005 inches.

17. The dynamic back pressure regulator of claim 1, further comprising a solenoid configured to limit displacement of the needle relative to the seat to control the restriction of fluid flow.

18. The dynamic back pressure regulator of claim 17, further comprising;
a head defining a portion of the fluid pathway, and
a body connecting the solenoid to the head.

19. The dynamic back pressure regulator of claim 18, wherein the needle comprises a proximal end that extends into the body, and a distal end that extends into the head.

20. The dynamic back pressure regulator of claim 18, further comprising a seat nut that engages the head to secure the seat therebetween.

21. The dynamic back pressure regulator of claim 20, wherein the head defines the inlet port and the seat nut defines the outlet port.

22. The dynamic back pressure regulator of claim 18, further comprising a seal disposed between the head and the body, wherein the needle extends through the seal.

23. The dynamic back pressure regulator of claim 18, further comprising a bushing disposed between the head and the body, wherein the needle extends through the bushing.

24. The dynamic back pressure regulator of claim 1, wherein the dynamic back pressure regulator is configured to regulate fluid pressure at the inlet port to a pressure within the range of about 1500 psi to about 6000 psi.

25-43. (canceled)
